(19) United States
(12) Patent Application Publication
(10) Pub. No.: US 2023/0013954 A1
(43) Pub. Date: Jan. 19, 2023

(54) EXTENSION SPRING ASSEMBLY AND METHOD FOR MANUFACTURING THE SAME

(71) Applicant: S3 ENTERPRISES INC., Swift Current (CA)

(72) Inventors: Al PENNER, Saskatchewan (CA); Joe GALLANT, Saskatchewan (CA); Braden LANG, Saskatoon (CA)

(21) Appl. No.: 17/955,612

(22) Filed: Sep. 29, 2022

Related U.S. Application Data
(62) Division of application No. 17/253,360, filed on Dec. 17, 2020.

(51) Int. Cl. F16F 1/12; B25B 11/00

(52) U.S. Cl. CPC F16F 1/125; B25B 11/00; F16F 1/024

(57) ABSTRACT

An extension spring assembly and a method for manufacturing the same. A helical extension spring is provided. The spring has a plurality of coils disposed along a longitudinal axis between an end coil at a first end and an end coil at a second end with the coils touching each other in absence of a force acting on the extension spring that is sufficient for extending the same. The end coils are gripped and the spring is extended to an extended position. In the extended position the spring has a predetermined distance between successive coils thereof In the extended position a coating material is disposed onto the surface of the spring such that the coating material is disposed onto a surface portion of the spring where the coils touch each other in absence of extension. The coating material is cured for a predetermined time interval while the spring is extended. The extension is removed from the spring after elapse of the predetermined time interval and the end coils are released. End mounts are then inserted into a first and a second end portion of the spring.

### CROSS-REFERENCE TO RELATED APPLICATIONS

This application is a divisional of U.S. patent application Ser. No. 17/253,360, filed on Dec. 17, 2020 and entitled Extension Spring Assembly And Method For Manufacturing the Same, which is a national stage filing of International Patent Application No. PCT/CA2018/000123 filed Jun. 19, 2018 (corresponding to International Publication No. WO 2019/241868). The entire contents of both of those Applications are hereby incorporated by reference.

### FIELD

The present invention relates to extension springs, and more particularly to an extension spring assembly comprising end mounts, a method for manufacturing the same, and a gripping tool for extending the extension spring during manufacture.

### BACKGROUND

Typically, extension springs are helical extension springs comprising a plurality of coils disposed along a longitudinal axis between a first end and a second end. Extension springs are manufactured in various sizes and for various loads, i.e. pulling forces required for extending the same. In numerous applications the coils of the extension springs touch each other in the absence of pulling force acting on the first and the second end of the extension spring that is sufficient for extending the same. Furthermore, for some applications extension springs are provided with the coils pushing against each other creating a “preload”. In use, a sufficiently large initial pulling force has to be applied in order to start the extension of the spring.

In present day manufacturing processes, the inside and the outside of the coils of the extension springs are often coated, as well as the surface portion of the extension spring where the coils touch one another. In order to coat the surface portion of the extension spring where the coils touch one another, the extension spring is extended and mounted, for example, to a sufficiently strong frame structure. While mounted to the frame structure, the coating is applied to the extension spring. After curing of the coating, the extension spring is removed from the frame structure. This process works well for extension springs having the end portions shaped forming hooks or loops for mounting.

Some extension springs are provided as extension spring assemblies having threaded end mounts turned into one or both ends both for mounting in order to replace the hooks or loops, which tend to break in high tension and/or high cycle applications.

Unfortunately, when the end mounts are turned into the extension springs in the process of extending the extension spring for coating, the coating material cannot reach the spaces between the coils that are in contact with the end mounts, or the inside surface of these coils. This provides opportunity for corrosion in these critical areas, frequently resulting in breakage of the extension springs, even if the end mounts and the extension springs have been coated for corrosion protection. In many situations when extension springs are mounted into machinery, it is very costly and time consuming to replace the same, or to remove them for repair/refurbishment, including recoating. Corrosion in extension springs can occur under the paint or coating layers. Thus, the corrosion is not readily visible and may go unnoticed. Extension springs that experience corrosion often fail suddenly under load, which can result in substantial damage to the machine and pose a substantial safety hazard to people in the immediate area.

It may be desirable to provide an extension spring assembly wherein the coating material is disposed on the inside surface, the outside surface, and the surface portion where the coils touch each other extending from the end coil at the first end to the end coil at the second end and including the end coils.

It also may be desirable to provide a method for manufacturing an extension spring assembly wherein the helical extension spring is extended and coated absent the end mounts.

It also may be desirable to provide a gripping tool for gripping an end coil of a helical extension spring.

### SUMMARY

Accordingly, one object of the present invention is to provide an extension spring assembly wherein the coating material is disposed on the inside surface, the outside surface, and the surface portion where the coils touch each other extending from the end coil at the first end to the end coil at the second end and including the end coils.

Another object of the present invention is to provide a method for manufacturing an extension spring assembly wherein the helical extension spring is extended and coated absent the end mounts.

Another object of the present invention is to provide a gripping tool for gripping an end coil of a helical extension spring.

According to one aspect of the present invention, there is provided a method for manufacturing an extension spring assembly. A helical extension spring is provided. The spring has a plurality of coils disposed along a longitudinal axis between an end coil at a first end and an end coil at a second end with the coils touching each other in absence of a force acting on the extension spring that is sufficient for extending the same. The end coils are gripped and the spring is extended to an extended position. In the extended position the spring has a predetermined distance between successive coils thereof In the extended position a coating material is disposed onto the surface of the spring such that the coating material is disposed onto a surface portion of the spring where the coils touch each other in absence of extension. The coating material is cured for a predetermined time interval while the spring is extended. The extension is removed from the spring after elapse of the predetermined time interval and the end coils are released. End mounts are then inserted into a first and a second end portion of the spring.

According to one aspect of the present invention, there is provided a method for manufacturing an extension spring assembly. A helical extension spring is provided. The spring has a plurality of coils disposed along a longitudinal axis between an end coil at a first end and an end coil at a second end with the coils touching each other in absence of a force acting on the extension spring that is sufficient for extending the same. A first and a second gripping tool are provided. The first and the second gripping tool are placed such that a first gripping element and a second gripping element of each of the first and the second gripping tool is in contact with an inside surface or an outside surface of the respective end coil at predetermined locations thereof. Using the gripping tools for gripping the end coils the spring is extended to an extended position. In the extended position the spring has a predetermined distance between successive coils thereof. In the extended position a coating material is disposed onto the surface of the spring such that the coating material is disposed onto a surface portion of the spring where the coils touch each other in absence of extension. The coating material is cured for a predetermined time interval while the spring is extended. The extension is removed from the spring after elapse of the predetermined time interval and the end coils are released. End mounts are then inserted into a first and a second end portion of the spring.

According to one aspect of the present invention, there is provided an extension spring assembly manufactured using the above method for manufacturing the same. The extension spring assembly has a coating material is disposed onto an inside surface of the helical extension spring, an outside surface of the helical extension spring, and a surface portion of the helical extension spring where the coils touch each other in absence of extension. The coating material is disposed on the inside surface, the outside surface, and the surface portion extending from the end coil at the first end to the end coil at the second end and including the end coils. The end mounts are inserted after coating of the helical extension spring.

According to one aspect of the present invention, there is provided a gripping tool for gripping an end coil of a helical extension spring. The gripping tool comprises a gripping tool body having a first gripping element and a second gripping element disposed at a first end thereof. The first gripping element and the second gripping element are spaced apart a predetermined distance corresponding to an inside diameter or an outside diameter of the end coil. The second gripping element is placed rearwardly from the first gripping element a predetermined distance corresponding to half a diameter of a spring wire forming the extension spring. The first gripping element and the second gripping element extend from the inside diameter outwardly or from the outside diameter inwardly a predetermined distance for securely gripping the end coil while the extension spring is un-extended. A connecting element is disposed rearwardly from the second gripping element, the connecting element is adapted for being connected to an actuator for extending the extension spring.

According to one aspect of the present invention, there is provided a gripping tool for gripping an end coil of a helical extension spring. The gripping tool comprises a gripping tool body having a first gripping element and a second gripping element disposed at a first end thereof. The first gripping element and the second gripping element are spaced apart a predetermined distance corresponding to an inside diameter or an outside diameter of the end coil. The second gripping element is placed rearwardly from the first gripping element a predetermined distance corresponding to half a diameter of a spring wire forming the extension spring. The first gripping element and the second gripping element extend from the inside diameter outwardly or from the outside diameter inwardly a predetermined distance for securely gripping the end coil while the extension spring is un-extended. The first gripping element and the second gripping element are adapted to fit into a space between the end coil and an adjacent coil touching the end coil. The first gripping element and the second gripping element each comprise a curved gripping surface having a curvature corresponding to a curvature of a cross section of the spring wire. A connecting element is disposed rearwardly from the second gripping element, the connecting element is adapted for being connected to an actuator for extending the extension spring.

An advantage of the present invention is that it provides an extension spring assembly wherein the coating material is disposed on the inside surface, the outside surface, and the surface portion where the coils touch each other extending from the end coil at the first end to the end coil at the second end and including the end coils.

A further advantage of the present invention is that it provides a method for manufacturing an extension spring assembly wherein the helical extension spring is extended and coated absent the end mounts.

A further advantage of the present invention is to provide a gripping tool for gripping an end coil of a helical extension spring.

### BRIEF DESCRIPTION OF THE DRAWINGS

An embodiment of the present invention is described below with reference to the accompanying drawings, in which:

FIGS. 1a and 1b are simplified block diagrams illustrating a side view of an extension spring assembly according to an embodiment of the invention with the extension spring being un-extended and extended, respectively;

FIGS. 2a and 2b are simplified block diagrams illustrating in a perspective side view and a side view, respectively, a gripping tool for gripping an end coil of a helical extension spring according to an embodiment of the invention;

FIGS. 2c and 2d are simplified block diagrams illustrating in side views a front portion of the gripping tool for gripping an end coil of a helical extension spring according to an embodiment of the invention;

FIGS. 3a, 3b, 3c, 3d and 3e are simplified block diagrams illustrating in perspective side views insertion of the gripping tool for gripping an end coil of a helical extension spring according to an embodiment of the invention into an end coil of the helical extension spring;

FIG. 4 is a simplified flow diagram illustrating a method for manufacturing an extension spring assembly according to an embodiment of the invention; and,

FIGS. 5a, 5b, 5c and 5d are simplified block diagrams illustrating in side views variations of the gripping tool for gripping an end coil of a helical extension spring according to an embodiment of the invention.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

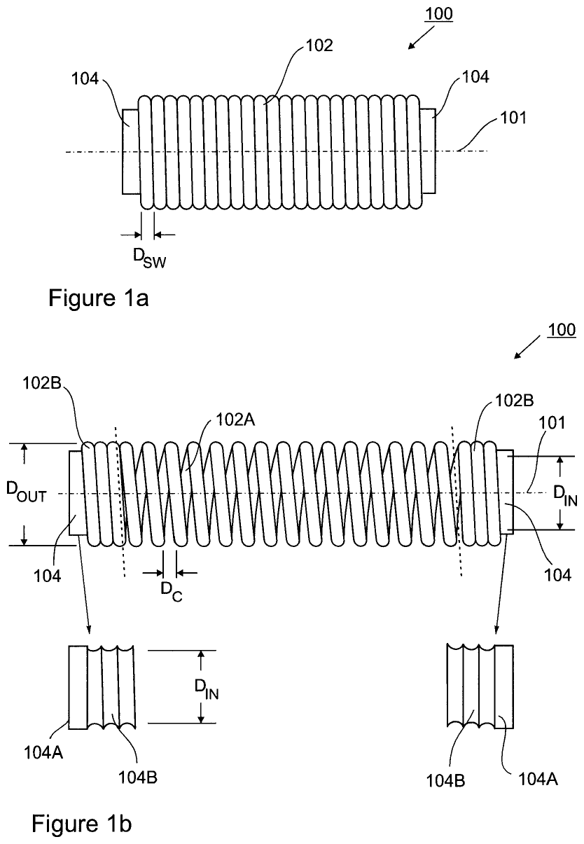

Referring to FIGS. 1a and 1b an extension spring assembly 100 according to an embodiment of the invention is provided. The extension spring 100 comprises coil member 102 and end mounts 104. The helical extension spring 102 has a plurality of coils disposed along longitudinal axis 101 between a first end and a second end with the coils touching each other in absence of pulling force acting on the spring that is sufficient for extending the same. The end mounts 104 each comprise a mounting portion 104A and a threaded coil interacting portion 104B. The coil interacting portions 104B are mounted in a screw type fashion into end portions 102B of the extension spring 102. With the coils of two end portions 102B being substantially fixed with respect to each other by interacting with the respective coil interacting portions 104B of the end mounts 104, the extension of the spring is provided by the plurality of coils of portion 102A disposed therebetween, as illustrated by the dashed lines in FIG. 1b.

Employment of a state of the art manufacturing process provides coating of the extension spring 102 while the same is extended with the end mounts 104 being inserted into the two end portions 102B for applying the necessary pulling force for extending the same. Unfortunately, the coating material cannot reach the spaces between the coils or the inside surface of these coils that are in contact with the end mounts 104 in the end portions 102B, providing opportunity for corrosion in these critical areas.

Employment of a method for manufacturing the extension spring assembly 100 combined with a gripping tool for gripping an end coil of the extension spring 102, described hereinbelow, ensures that the coating material is disposed onto an inside surface of the extension spring 102, an outside surface of the extension spring 102, and a surface portion of the extension spring 102 where the coils touch each other in absence of extension along the complete length of the extension spring 102 extending from the end coil at the first end to the end coil at the second end and including the end coils. The end mounts 104 are inserted into the end portions 102B of the extension spring 102 after the coating has been cured.

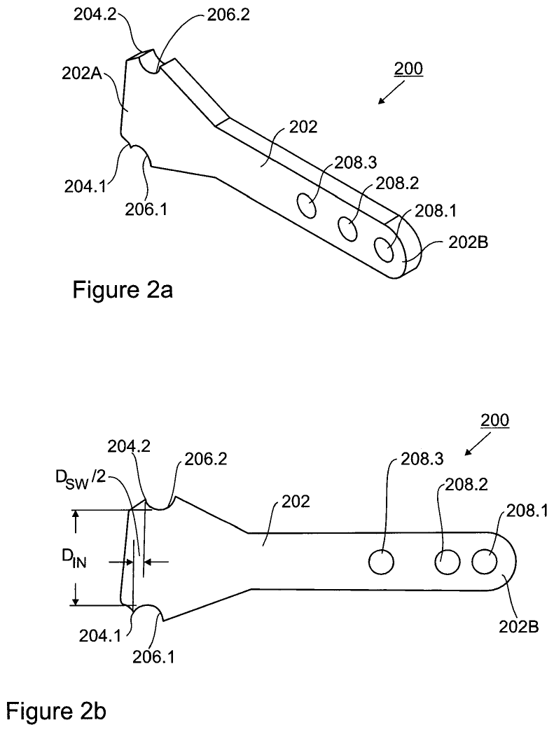

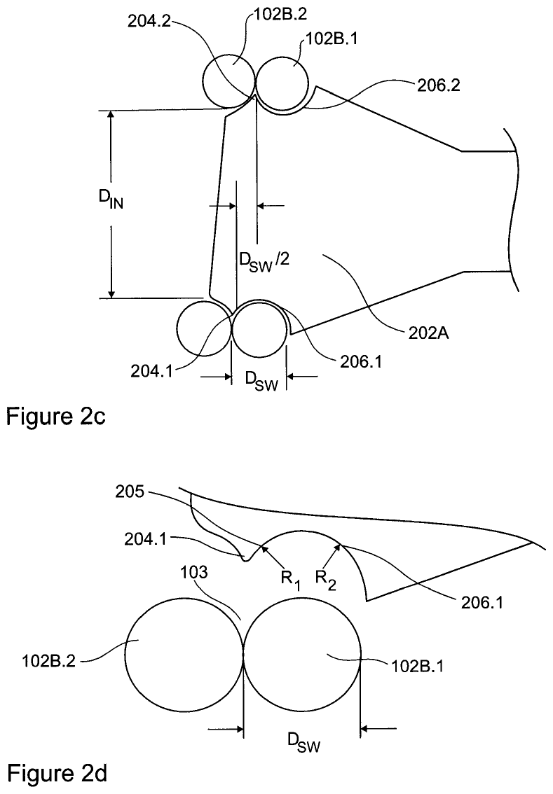

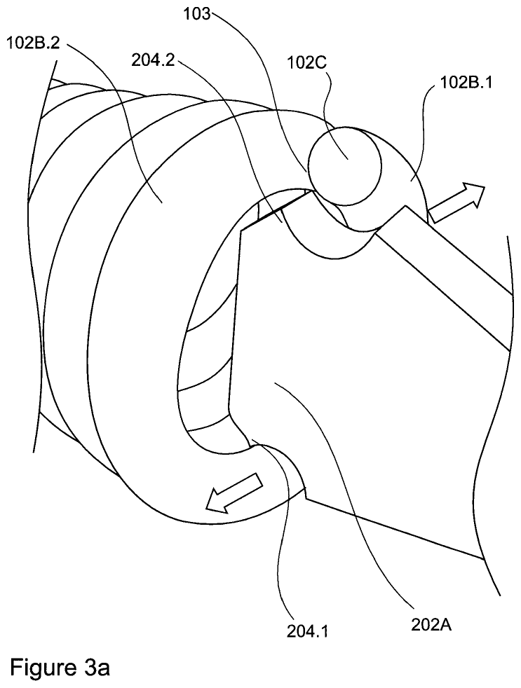

Referring to FIGS. 2a to 2d, a gripping tool 200 for gripping an end coil of an extension spring according to an embodiment of the invention is provided. The gripping tool 200 comprises a gripping tool body 202 having a first gripping element 204.1 and a second gripping element 204.2 disposed at a first end 202A of the gripping tool body 202. The gripping tool body 202 can be substantially flat and elongated.

The first gripping element 204.1 and the second gripping element 204.2 are spaced apart a predetermined distance corresponding to an inside diameter D_{IN} of the end coil 102B.1. The second gripping element 204.2 is placed rearwardly from the first gripping element 204.1 a predetermined distance corresponding to half a diameter D_{SW} of a spring wire forming the extension spring 102. The first gripping element 204.1 and the second gripping element 204.2 extend from the inside diameter outwardly a predetermined distance for securely gripping the inside surface of the end coil 102B.1 while also fitting into a space 103 between the end coil 102B.1 and an adjacent coil 102B.2 touching the end coil 102B.1 of the un-extended extension spring 102, as illustrated in FIGS. 2c and 2d.

Connecting elements such as, for example, bores 208, disposed in the gripping tool body 202 rearwardly from the second gripping element 204.2. A plurality of connecting elements 208.1, 208.2, 208.3 can be placed at different locations along the gripping tool body 202. For example, connecting element 208.1—placed in proximity of a second end 202B of the gripping tool body 202—is used for connecting the gripping tool 200 to an actuator for extending the extension spring 102 while one of the other connecting elements 208.2, 208.3 are used for mounting the extension spring to a frame structure while being extended. Placement of a plurality of connecting elements along the gripping tool body 200 enables use of the same gripping tool 200 for extension springs 102 having different lengths.

Each of the first gripping element 204.1 and the second gripping element 204.2 can comprise a curved gripping surface 205 having a curvature R₁ corresponding to a curvature D_{SW}/2 of a cross section of the spring wire in order to increase the contact area between the gripping elements 204.1, 204.2 and the end coil 102B.1, as illustrated in FIG. 2d.

Each of the first gripping element 204.1 and the second gripping element 204.2 can be connected to a gripping structure 206.1 and 206.2, respectively. Each of the gripping structures 206.1 and 206.2 surround a predetermined section of the spring wire and, in one case, have a curvature R₂ corresponding to a curvature D_{SW}/2 of the cross section of the spring wire or slightly larger. The gripping structures 206.1 and 206.2 facilitate insertion of the gripping tool 200 into the extension spring 102 by guiding the gripping tool 200 when rotated into the end coil 102B.1, as will be described hereinbelow.

The gripping tool 200 is made of, for example, sufficiently thick steel sheet material—depending on the pulling force employed for extending the extension spring 102—using conventional technologies such as forging, cutting, and drilling.

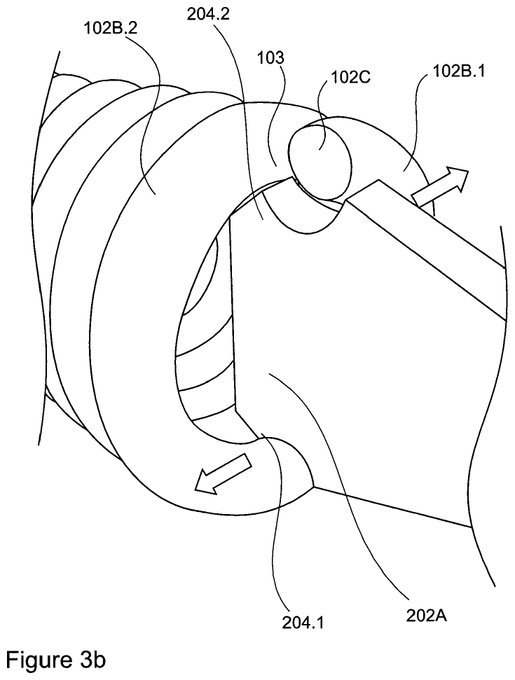

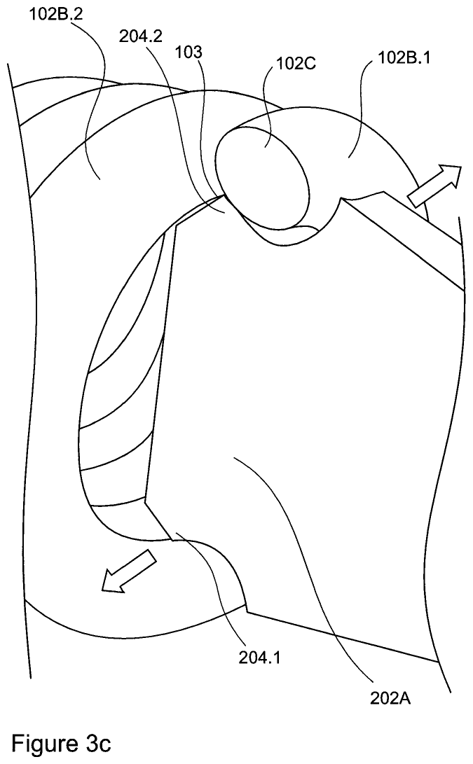

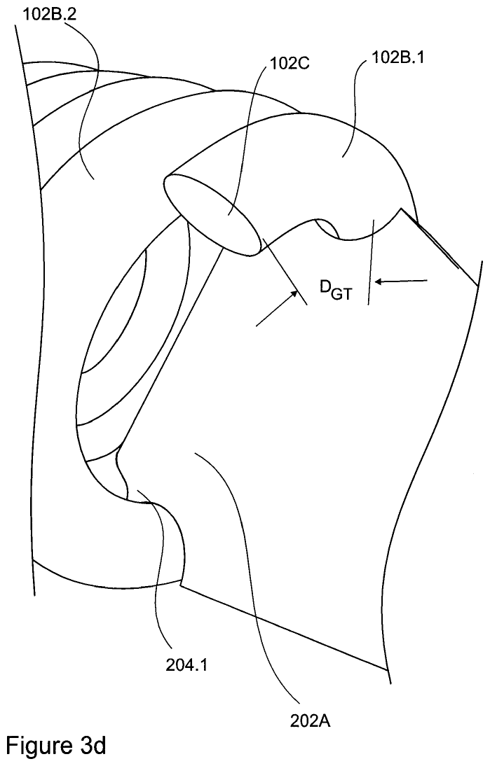

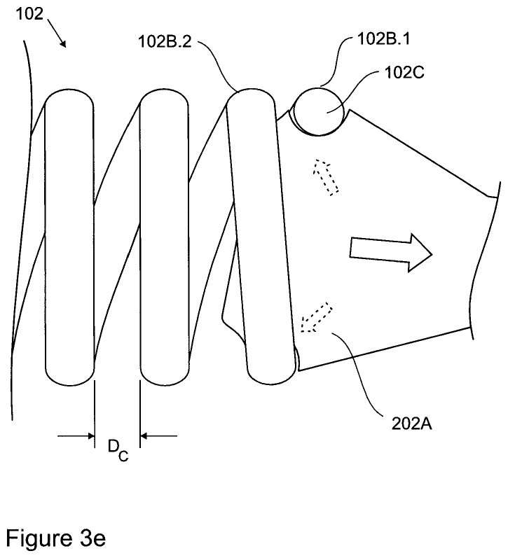

FIGS. 3a to 3e illustrate a method for inserting the gripping tool 200 into the extension spring 102. First, the first gripping element 204.1 is engaged with the end coil 102B.1 at a location approximately opposite an end 102C of the end coil 102B.1, as illustrated in FIG. 3a. The gripping tool 200 is then rotated with the engaged first gripping element 204.1 following the end coil 102B.1 until the second gripping element 204.2 reaches the end 102C of the end coil 102B.1, as indicated by the block arrows in FIGS. 3a and 3b. The second gripping element 204.2 is then engaged with the end 102C of the end coil 102B.1 and rotated further with the engaged first 204.1. and second gripping elements 204.2 following the coil until the second gripping element is placed a predetermined distance D_{GT} from the end 102C of the end coil 102B.1, as illustrated in FIGS. 3c and 3d. The distance D_{GT} is determined such that the gripping tool remains securely engaged with the end coil 102B.1 during extending the extension spring 102, mounting of the gripping tools 200 to a frame structure and during coating and curing.

Optionally, the first gripping element 204.1 is engaged with the end 102C of the end coil 102B.1 and the gripping tool 200 is then rotated with the engaged first gripping element 204.1 following the end coil 102B.1 until the first gripping element 204.1 reaches the location approximately opposite the end 102C of the end coil 102B.1. The following steps are the same as described hereinabove.

With the gripping tools 200 being securely engaged with the end coils 102B.1 at both ends of the extension spring 102 a pulling force is applied for extending the extension spring 102 such that there is a predetermined distance Dc between successive coils thereof, as indicated by the block arrow in FIG. 3e. It is noted that only one end of the extension spring 102 is shown in FIG. 3e for simplicity. Employment of the gripping tools 200 ensures that the coating material is also disposed onto an inside surface of the extension spring 102, an outside surface of the extension spring 102, and a surface portion of the extension spring 102 where the coils touch each other in absence of extension along the complete length of the extension spring 102 extending from the end coil 102B.1 at the first end to the end coil 102B.1 at the second end and including the ends 102C of the end coils 102B.1, except for two small areas prevented from coating due to the presence of the gripping elements 204.1 and 204.2, as indicated by the dashed block arrows in FIG. 3e, which can be touched-up when the extension spring 102 is un-extended after removal of the gripping tools 200.

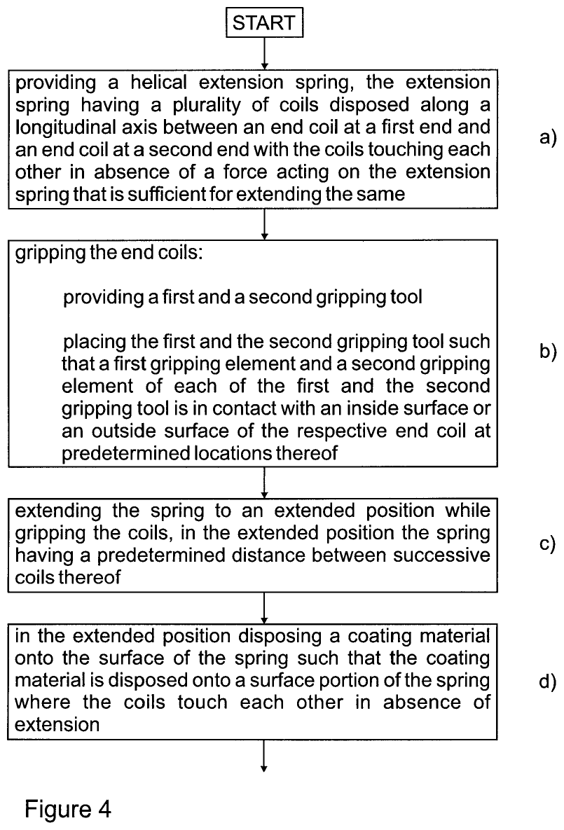

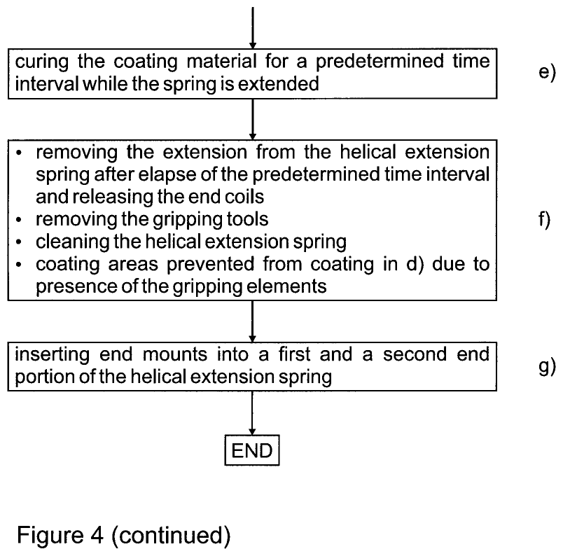

Referring to FIG. 4, a method for manufacturing an extension spring assembly according to an embodiment of the invention is provided. At a) a helical extension spring 102 having a plurality of coils disposed along a longitudinal axis between an end coil at a first end and an end coil at a second end with the coils touching each other in absence of a force acting on the extension spring that is sufficient for extending the same is provided. Using the gripping tools 200 the end coils are gripped—b)—by placing the gripping tools 200 such that the first gripping element 204.1 and a second gripping element 204.2 of each of the gripping tools 200 is in contact with an inside surface of the respective end coil 102B.1 at predetermined locations thereof using the method for inserting the gripping tool 200 into the extension spring 102 described hereinabove. With the gripping tools 200 being securely engaged with the end coils 102B.1 at both ends of the extension spring 102 a pulling force is applied for extending—c)—the extension spring 102 such that there is a predetermined distance Dc between successive coils thereof, as indicated by the block. In the extended position a coating material is disposed—d)—onto an inside surface of the extension spring 102, an outside surface of the extension spring 102, and a surface portion of the extension spring 102 where the coils touch each other in absence of extension along the complete length of the extension spring 102 extending from the end coil 102B.1 at the first end to the end coil 102B.1 at the second end and including the ends 102C of the end coils 102B.1. The coating material may include any conventional coating material such as, for example, liquid paint, powder coat, or e-coat applied using various conventional application methods such as, for example, plating, spraying, or dipping. After curing—e)—the coating material for a predetermined time interval while the extensions spring is extended, the extension is removed—f)—and the end coils 102B.1 are released from the gripping tools 200 using the above insertion process in reverse. After removal of the gripping tools 200 the extension spring is cleaned—in particular, areas where debris may have become trapped between the end coils 102B.1 and the gripping tool 200—and the small areas prevented from coating in d) due to presence of the gripping elements are touched-up using, for example, enamel spray paint. The end mounts 104 are then inserted into the end portions 102B of the extension spring 102 forming the extension spring assembly 100.

In an exemplary implementation, the process has been employed for powder coating a spring having: an inside diameter D_{IN} of 2.5″; a spring wire diameter D_{SW} of 0.625″; a predetermined distance Dc between successive coils when extended of 0.15″; a load rate of 212 lbs./in; and a preload of 750 lbs. The gripping tool 200 has an overall length of 8″ with the gripping tool body 202 having a rectangular cross section of 1.5″×0.5″ and is made of 44W steel.

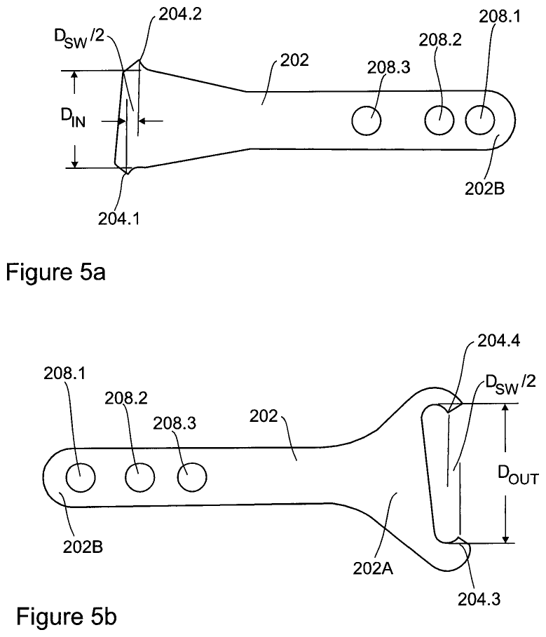

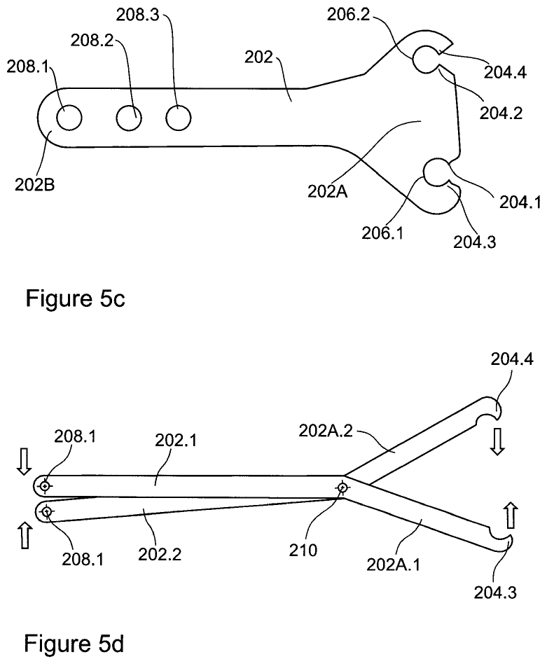

FIGS. 5a to 5d illustrate variations of the gripping tool 200. The gripping tool illustrated in FIG. 5a is a simpler version of the gripping tool 200 with the gripping structures 206.1 and 206.2 being omitted.

FIG. 5b illustrates the gripping tool 200 adapted for gripping an outside surface of the end coil 102B.1. Here gripping elements 204.3 and 204.4 are spaced apart a predetermined distance corresponding to an outside diameter D_{OUT} of the end coil 102B.1. The gripping element 204.4 is placed rearwardly from the gripping element 204.3 a predetermined distance corresponding to half a diameter D_{SW} of the spring wire forming the extension spring 102. The gripping elements 204.3, 204.4 extend from the outside diameter D_{OUT} inwardly a predetermined distance for securely gripping the end coil 102B.1 while the extension spring is un-extended. Each of the gripping elements 204.3 and 204.4 can comprise a curved gripping surface having a curvature corresponding to a curvature D_{SW}/2 of a cross section of the spring wire in order to increase the contact area between the gripping elements 204.3, 204.4 and the end coil 102B.1. This gripping tool is inserted into the end coil 102B.1 in a similar manner as the gripping tool 200.

The gripping tool illustrated in FIG. 5c is a combination of the gripping tool 200 with the gripping tool illustrated in FIG. 5b, resulting in gripping elements 204.3 and 204.4 being disposed opposite the gripping elements 204.1 and 204.2, respectively. Gripping structures 206.1 and 206.2 can connect the gripping elements 204.1 with 204.3 and 204.2 with 204.4, respectively. Each of the gripping structures 206.1 and 206.2 can have a curvature corresponding to a curvature D_{SW}/2 of the cross section of the spring wire or slightly larger. The gripping tool is inserted by engaging the gripping elements 204.1 and 204.3 with the end 102C of the end coil 102B.1. The gripping tool is then rotated with the engaged gripping elements 204.1 and 204.3 following the end coil 102B.1 until the gripping elements 204.1 and 204.3 reach the location approximately opposite the end 102C of the end coil 102B.1. The gripping tool is then rotated further with the engaged gripping element 204.1 and 204.3 following the end coil 102B.1 until the gripping elements 204.2 and 204.4 reach the end 102C of the end coil 102B.1. The gripping elements 204.2 and 204.4 are then engaged with the end 102C of the end coil 102B.1. The gripping tool is then rotated further with the engaged gripping elements 204.1, 204.2, 204.3, and 204.4 following the end coil 102B.1 until the gripping elements 204.2 and 204.4 are placed a predetermined distance from the end 102C of the end coil 102B.1.

Optionally, the gripping tool is provided with only one arm comprising the gripping elements 204.1 and 204.3.

FIG. 5d illustrates a gripping tool with the gripping tool body comprising a first arm 202.1 with gripping element 204.3 and a second arm 202.2 with gripping element 204.4. The first arm 202.1 is pivotally movable connected to the second arm 202.2 at pivot 210, as indicated by the block arrows. While FIG. 5d illustrates the gripping tool for gripping the outside surface of the end coil 102B.1, the gripping tool is also adaptable for gripping the inside surface of the end coil 102B.1.

It is noted, that in one case gripping tools comprising only gripping elements 204.1 and 204.2 can be employed for gripping the inside surface of the end coil 102B.1 since the touched-up contact areas are covered by the end mounts 104.

Alternatively, the extension spring 102 is extended without the gripping tools 200 by manufacturing the extension spring with hooks or loops at the ends thereof. The extension spring 102 is then extended by gripping the hooks or loops. After the coating material disposed onto the extension spring 102 is cured, the extension spring is released and the hooks or loops are cut off prior to the insertion of the end mounts 104 to form the extension spring assembly 100. However, extreme care has to be taken that, during the process of cutting off the hooks or loops, the coil 102B.2 adjacent to the end coil 102B.1 is not damaged or the coating of the end portion 102B is not damaged due to sparks or cutting debris, which may result in opportunity for corrosion or weak points in these critical areas.

Further alternatively, the extension spring 102 is manufactured with hooks or loops at the ends thereof as above, but the hooks or loops are formed small enough and placed such that the end mounts can be inserted with the hooks or loops remaining. However, extreme care has to be taken that, during the process of forming the hooks or loops, the coils of the extension spring 102 are not distorted.

The present invention has been described herein with regard to certain embodiments. However, it will be obvious to persons skilled in the art that a number of variations and modifications can be made without departing from the scope of the invention as described herein.

What is claimed is:

1. A method for coating a helical extension spring comprising:
a) providing the helical extension spring, the helical extension spring having a plurality of coils disposed along a longitudinal axis between an end coil at a first end and an end coil at a second end with the coils touching each other from an end of the end coil at the first end to an end of the end coil at the second end in absence of a force acting on the spring that is sufficient for extending the same;
b) gripping the end coils;
c) extending the helical extension spring to an extended position while gripping the end coils, in the extended position the helical extension spring having a predetermined distance between successive coils thereof;
d) in the extended position disposing a coating material onto the surface of the helical extension spring such that the coating material is disposed onto:
an inside surface of the helical extension spring;
an outside surface of the helical extension spring; and,
a surface portion of the helical extension spring where the coils touch each other in absence of the extension;
along the complete length of the helical extension spring from an end of the end coil at the first end to an end of the end coil at the second end and including the ends of the end coils, except for small areas where the end coils are gripped;
e) curing the coating material for a predetermined time interval while the helical extension spring is extended; and,
f) removing the extension from the helical extension spring after elapse of the predetermined time interval and releasing the end coils.

2. The method according to claim 1 wherein b) comprises:
providing a first and a second gripping tool; and,
placing the first and the second gripping tool such that a first gripping element and a second gripping element of each of the first and the second gripping tool is in contact with an inside surface or an outside surface of the respective end coil at predetermined locations thereof.

3. The method according to claim 2 comprising:
engaging the first gripping element with the end coil at a location approximately opposite an end of the end coil;
rotating the gripping tool with the engaged first gripping element following the coil until the second gripping element placed rearwardly from the first gripping element reaches the end of the end coil;
engaging the second gripping element with the end of the end coil; and,
rotating the gripping tool further with the engaged first and second gripping elements following the coil until the second gripping element is placed a predetermined distance from the end of the end coil.

4. The method according to claim 2 comprising:
engaging the first gripping element with the end coil at a predetermined distance from an end of the end coil; and,
moving the second gripping element with respect to the first gripping element until the second gripping element engages the end coil.

5. The method according to claim 2 comprising:
engaging the first gripping element with the end of the end coil;
rotating the gripping tool with the engaged first gripping element following the coil until the second gripping element placed rearwardly from the first gripping element reaches the end of the end coil;
engaging the second gripping element with the end of the end coil; and,
rotating the gripping tool further with the engaged first and second gripping elements following the coil until the second gripping element is placed a predetermined distance from the end of the end coil.

6. The method according to claim 5 comprising:
engaging a third gripping element together with the first gripping element, the third gripping element being disposed opposite the first gripping element; and,
engaging a forth gripping element together with the second gripping element, the forth gripping element being disposed opposite the second gripping element.

7. The method according to claim 2 comprising:
engaging the first gripping element together with the second gripping element with an end of the end coil, the second gripping element being disposed opposite the first gripping element; and,
rotating the gripping tool with the engaged first and second gripping elements following the coil until the first and second gripping elements are placed a predetermined distance from the end of the end coil.

8. The method according to claim 1 wherein f) comprises:
removing the gripping tools;
cleaning the helical extension spring; and,
touching-up the small areas where the end coils were gripped.

9. A helical extension spring coated using the method according to claim 1 wherein a coating material is disposed onto:
an inside surface of the helical extension spring;
an outside surface of the helical extension spring; and,
a surface portion of the helical extension spring where the coils touch each other in absence of the extension; and
along the complete length of the helical extension spring from an end of the end coil at the first end to an end of the end coil at the second end and including the ends of the end coils, except for small areas where the end coils are gripped.

10. The helical extension spring according to claim 9 wherein the small areas are touched-up.

11. The helical extension spring according to claim 10 comprising end mounts inserted into a first and a second end portion of the spring.
